(19) United States
(12) Patent Application Publication
(10) Pub. No.: US 2003/0139131 A1
(43) Pub. Date: Jul. 24, 2003

(54) Knife for a cutlet cutter

(75) Inventor: Nobert Lay, Bondorf (DE)

Correspondence Address: Felix J. D'Ambrosio, JONES, TULLAR & COOPER, P.C., P.O. Box 2266 Eads Station, Arlington, VA, 22202, US

(73) Assignee: Schmid & Wezel GmbH & Co.

(21) Appl. No.: 10/350,231

(22) Filed: Jan. 24, 2003

(30) Foreign Application Priority Data
Jan. 24, 2002 (DE) 102 02 861.3

(51) Int. Cl. A22C 17/00

(52) U.S. Cl. 452/149; 452/135; 264/157; 99/538

(57) ABSTRACT

Knives (10, 20) for carving out meat slabs (1), whose cutting edges (14, 24) are ground in such a way that they do not cut into the rib bones (2), or back bones), and at the same time assure cutting as closely as possible to the rib or back bones.

### DESCRIPTION

The invention relates to a knife for the mechanical separation of a meat slab from the rib bones of a portion of a slaughtered animal, containing the meat slab, the associated rib bones and the associated back bones. The invention furthermore relates to a knife for the mechanical separation of a meat slab from the back bone of a portion of a slaughtered animal, containing the meat slab, the associated back bones and the associated rib bones.

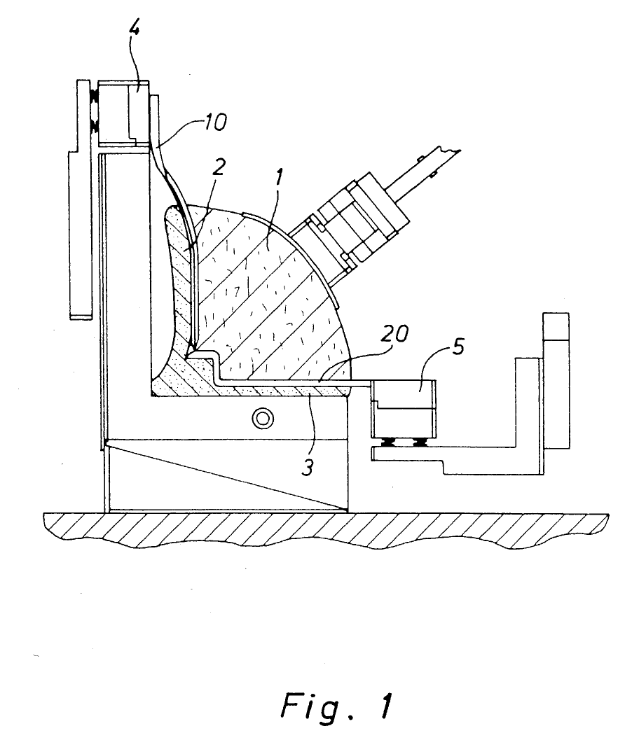

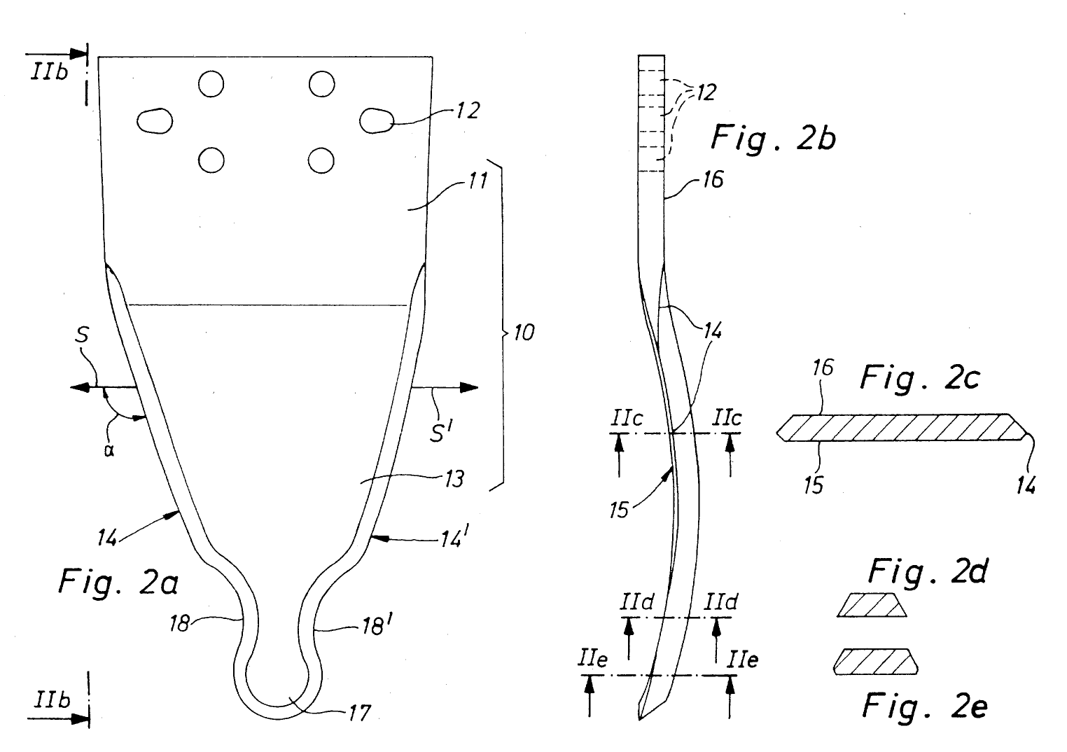

Such knives are disclosed in the older German patent application 100 37 300.3 (see FIG. 2, reference numerals 9, 10) and are represented in FIG. 1 of the present application. This arrangement with a portion of a slaughtered animal consisting of the meat slab 1, the rib bones 2 and the back bones 3 is represented in FIG. 1. It has a knife 10 for separating the meat slab 1 from the rib bones 2, and a knife 20 for separating the meat slab from the back bone 3. The knife 10 is connected to the drive mechanism 4, which can be linearly displaced vertically in respect to the drawing plane, the knife 20 is connected to a drive mechanism 5, which is also displaceable.

The object of the present invention is based on improving the efficiency of these two knives, which are employed together for carving meat slabs. This means that, on the one hand, the cutting edges of the knives should not cut into the bone, but, on the other hand, should cut as closely as possible to the bone, i.e. so that all the meat is carved out with the meat slab.

The attainment of this object is achieved by means of the special design of the knives in accordance with the features recited in the characterizing portions of claims 1 or 5. Advantageous further developments of the invention are defined in the dependent claims.

Exemplary embodiments of the invention will be described in greater detail in what follows, making reference to the drawings.

FIG. 1 shows a perspective view of an arrangement in accordance with the prior art for separating a meat slab from the bones of a slaughtered animal,

FIG. 2a is a view from above on an exemplary embodiment of a knife 10 for separating the meat slab 1 from rib bones 2,

FIG. 2b is a plan view of the knife 10 in FIG. 2a in the direction of the arrows IIb-IIb,

FIG. 2c is a section along the arrows IIc-IIc in FIG. 2b,

FIG. 2d is a section along the arrows IId-IId in FIG. 2b,

FIG. 2e is a section along the arrows IIe-IIe in FIG. 2b,

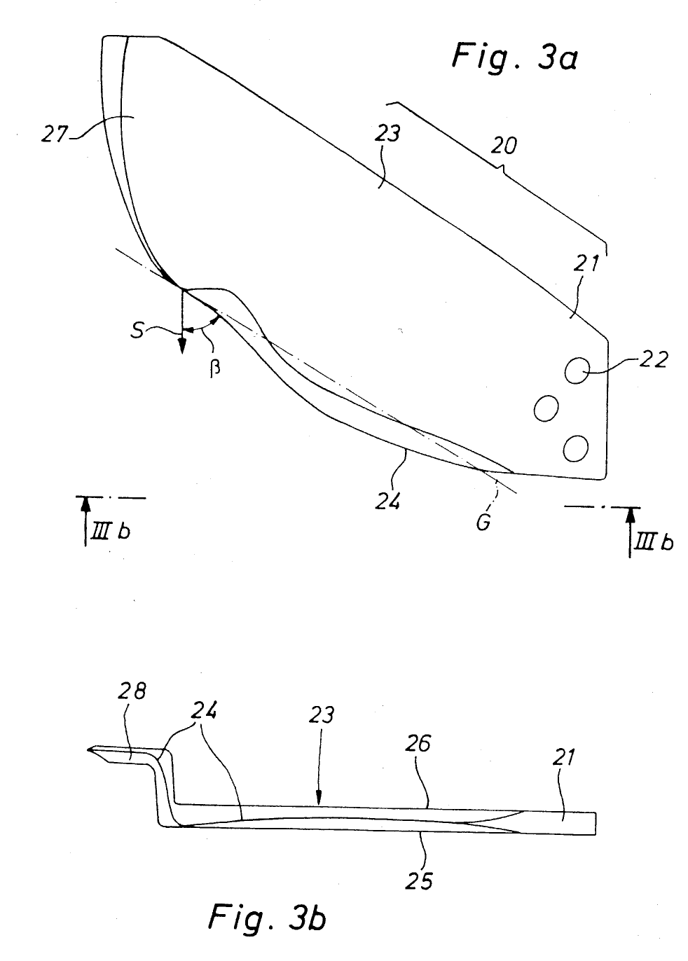

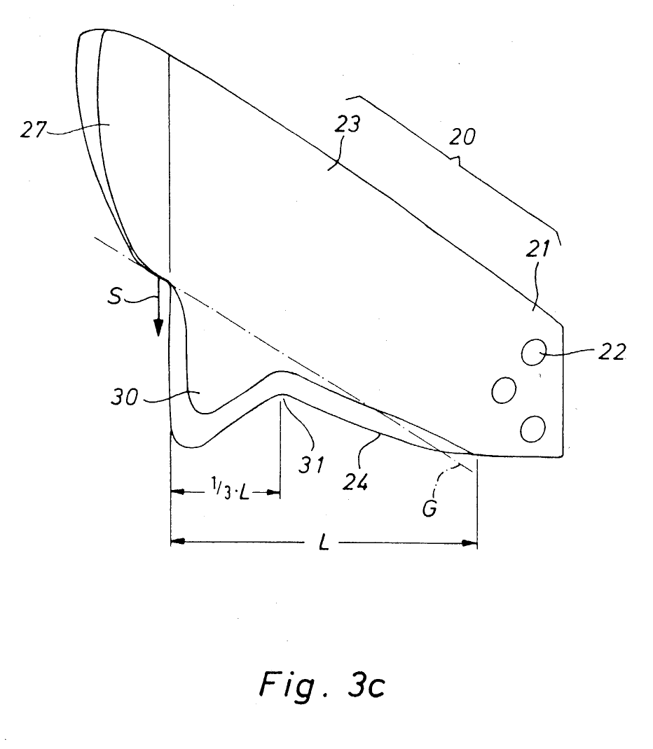

FIG. 3a is a view from above on an exemplary embodiment of a knife 20 for separating the meat slab 1 from the back bones 3,

FIG. 3b is a plan view of the knife 20 in FIG. 3a in the direction of the arrows IIIb-IIIb,

FIG. 3c is a view from above corresponding to FIG. 3a on a further exemplary embodiment on a knife 20.

The knife 10 is used for separating the meat slab 1 from the rib bones 2. The knife 10 consists of a fastening plate 11 and a plane, bulging area 13. The fastening plate 11 has bores 12. These are used for fastening the knife 10 to a drive mechanism 4. Since other options for fastening are also possible, reference is made in the claims to the fastening plate and the bores as “fastening means”. The shaping of the area 13 is used for adaptation to the curvature of the rib bones 2.

In FIG. 1, the cutting direction S extends vertically in relation to the drawing plane, in FIG. 2a in the direction of the inserted arrow S. The knife 10 has a cutting edge 14 in the cutting direction S, which is formed by grinding the parallel lateral faces 15, 16 of the knife 10, and which maintains a defined distance from the lateral face 15 of the knife 10 which rests against the rib bone 2. In the opposite cutting direction S′ it has a corresponding cutting edge 14′. As can be seen in FIG. 2a, the area 13 tapers between the two symmetrically arranged cutting edges 14, 14′ from the fastening plate 11 in the direction toward the free end area 17. This results in that the cutting edge 14 is set obliquely in the cutting direction S starting at its area located near the fastening plate 11 in the direction of its free end area 17 in such a way that the area close to the fastening plate 11 in front of the free end area 17 comes into cutting connection with the meat slab 1. The obliqueness of the cutting edge 14 in respect to the cutting direction S has an angle α of 80° to 50°, preferably 70°. The following is achieved by this: if the meat slab 1 is viewed along a line extending vertically in relation to the cutting direction, the cutting edge 14 first cuts the meat in the area near the fastening plate 11 because of the course of the cutting edge 14 provided by the oblique placement, and only thereafter cuts with the portion of the cutting edge which is set back in the movement direction and is assigned to the indentation 18 and the end area 17. Thus, while the cutting edge 14 cuts with the free end area 17 and in the area of the indentation 18, the portion of the meat slab 1 located above it and vertically in respect to the cutting direction S, which had already been cut, is held by the bulging plane area 13 of the knife. Thus, this oblique portion of the cutting edge 14, which is provided with the indentation 18, is for one used for an exact guidance of the cut, and furthermore for a force reduction, and by this assures a cut close to the bone with a maximum yield of meat and high cutting quality. A corresponding indentation 18′ is provided on the cutting edge 14′, which operates in the cutting direction S′.

Viewed in the cutting direction, the cutting edge 14 extends along a special course (FIG. 2b). It runs from the fastening plate 11 as far as the indentation 18 at a distance from the lateral face 15 resting against the rib bones 2, which amounts to a quarter to one-half of the thickness of the knife 10 (see FIG. 2c). Adjoining this, in the area of the indentation 18 the cutting edge 14 substantially runs in a linear continuation of the lateral face 15 of the knife 10 resting against the rib 2 (FIG. 2d), and in the free end section 17 of the knife 10 has a distance from the lateral face 15 of one fifth to one-half of the thickness of the knife 10 (FIG. 2e). The thickness of the knife 10 between the otherwise parallel lateral faces 15 and 16 is 3 to 5 mm, preferably 4 mm. As a whole, the cutting edge 14 describes a curve maintaining a defined distance from the lateral face 15. It is assured in this way that in the center cutting area the cutting edge is always guided through the lateral face 15 in the area 13 distanced by a defined minimum amount from the rib bone. By means of this the knife 10 is prevented from cutting into the rib bones.

In the exemplary embodiment the knife 10 is symmetrically embodied as a result of the arrangement of two cutting edges 14, 14′ for the opposite cutting directions S, S′.

FIG. 3a shows a front plan view of the knife 20 for separating the meat slab 1 from the back bones 3. The knife 20 is arranged substantially horizontally (FIG. 1) and has a fastening plate 21 and a flat area 23 which, at the free end of the knife 20, makes a transition into a step-shaped shoulder 28. The fastening plate 21 has bores 22 which are used for fastening the knife 20 on the drive mechanism 5. Since other options for fastening are also possible, reference to this is made in the claims as “fastening means”.

The step-shaped shoulder 28 is used for adaptation to the shape of the connection of the back bones 3 with the rib bones 2 (FIG. 3b).

In FIG. 3a, the cutting direction is also identified by an arrow S. The knife 20 has a cutting edge 24 in the cutting direction S, which is formed by grinding the otherwise parallel lateral faces 25, 26 and which maintains a defined distance from the lateral face 25 of the knife 20 resting against the back bone 3. As can be seen in FIG. 3a, the cutting edge 24 is placed obliquely from its area located near the fastening plate 21 up to its free end area 27—the same as the cutting edge 14 of the knife 10—in such a way that the area of the blade 23 close to the fastening plate 21 comes into cutting engagement with the meat slab 1 before the free end area 27. The curved area of the cutting edge 24, which is placed obliquely in respect to the cutting direction S, between the fastening plate 21 and the shoulder 28 can be approximately described by the straight line G shown in dash-dotted lines. The angle β between S and G is 20 to 70°, preferably approximately 45°. The effect of this design is analogous to the one already described in connection with the knife 10: the portion of the meat slab 1, which was just cut by the cutting edge 24 near the shoulder 28, is held by the flat area 23 during cutting, wherein in this area the cutting edge 24 precedes the shoulder 28. One the one hand, this assures a high yield of meat and, on the other hand, prevents cutting into the back bone 3.

The course of the cutting edge 24 viewed from the cutting direction, can be seen in FIG. 3b. It runs from the fastening plate 21 as far as the vicinity of the shoulder 28 at a distance from the lateral face 25 resting against the back bone 3, which is a quarter to one-half of the thickness of the knife 20, which itself is 3 to 5 mm, preferably approximately 4 mm. Adjoining this, in the area of the transition into the step-shaped shoulder 28, the cutting edge 24 comes closer to the lateral face 25 by one-tenth to one-third. It can also completely lie in a linear continuation of the lateral face 25. The cutting edge 24 has an S-shape in the area of the shoulder 28. Toward the end of the higher located area of the shoulder 28, the cutting edge 24 has a distance of one-half to three-quarters of the thickness of the knife 20 from the lateral face 25. As a whole, the course of the cutting edge 24 describes a curve, which has a z-shape and runs out slowly between the lateral faces 25 and 26 and maintains a defined distance from the lateral face 25.

In the exemplary embodiment in FIG. 3c, the cutting edge 24 has a protrusion prior to the transition of the area 23 into the shoulder 28, which takes up approximately one-third of the distance L between the border of the area 23 and the fastening plate 21 and the shoulder 28. In this way an indentation, namely an indentation 31, is also created in the knife 20. This shape has also been shown to be advantageous.

What is claimed is:

1. A knife (10) for the mechanical separation of a meat slab (1) from the rib bones (2) of a portion of a slaughtered animal, containing the meat slab (1), the associated rib bones (2) and the associated back bones (3), which
(a) for matching the curvature of the rib bones (2) has a plane bulging curved area (13), and
(b) is provided with means (11, 12) for fastening the knife (10) to a drive mechanism (4), and
(c) has a cutting edge (14) in the cutting direction (S), which is formed by grinding the parallel lateral faces (15, 16) of the knife (10) and has a defined distance from the lateral face (15) of the knife (10) which rests against the rib bones (2),
characterized in that
(d) the cutting edge (14) has been set obliquely in respect to the cutting direction (S) from its area located near the fastening means to its free end area (17) in such a way that the area (13) near the fastening means comes into cutting engagement with the meat slab (1) before the free end area (17) does,
(e) near its free end (17), the cutting edge (14) has an indentation (18) extending over approximately one-third of the length of the knife (10), and
(f) moreover, the cutting edge (14) extends from its end near the fastening means (11, 12) up to the indentation (18) at a distance from the lateral face (15) resting against the rib bones (2), which amounts to ¼ to ½ of the thickness of the knife (10),
(g) adjoining this it extends in the area of the indentation (18) substantially in a linear continuation of the lateral face (15) of the knife (10) resting against the rib bone (2), and
(h) at the free end (17) of the knife (10) has a distance of from ⅕ to ½ the thickness of the knife (10) from the said lateral face (15).

2. The knife in accordance with claim 1, characterized in that the knife (10) has two cutting edges (14, 14′), which are embodied to be symmetrical in respect to each other, for cutting in opposite cutting directions (S, S′), so that respectively one of the cutting edges (14, 14′) comes into cutting engagement in one direction of the two linear movement directions (S, S′).

3. The knife in accordance with claim 1 or 2, characterized in that the thickness of the knife (10) is 3 to 5 mm, preferably approximately 4 mm.

4. The knife in accordance with one of claims 1 to 3, characterized in that the oblique positioning of the cutting edge (14) in respect to the cutting direction (S) has an angle of 80 to 50°, preferably 70°.

5. A knife (20) for the mechanical separation of a meat slab (1) from the back bone (3) of portion of a slaughtered animal, containing the meat slab (1), the associated back bones (3) and the associated rib bones (2), which
(a) for resting against the back bone (3) has a plane area (23), and
(b) is provided with means (21, 22) for fastening on a drive mechanism (5), and
(c) has a cutting edge (24) in the cutting direction (S), which is formed by grinding the parallel lateral faces (25, 26) of the knife, and
(d) has a step-shaped shoulder (28) on its free end (27) facing away from the fastening means (21, 22) for adaptation to the shape of the connection of the back bones (3) with the rib bones (2),
characterized in that
(e) the cutting edge (24) has been set obliquely in respect to the cutting direction (S) from its area located near the fastening means (21, 22) to its free end area (27) in such a way 20 that the area near the fastening means (21, 22) comes into cutting engagement with the meat slab (1), and
(f) moreover, the cutting edge (24) extends from its end near the fastening means (21, 22) up to the said shoulder (28) at a distance from the lateral face (25) resting against the back bone (3), which amounts to ¼ to ½ of the thickness of the knife (20),
(g) adjoining this it extends in the area of the transition into the shoulder (28) comes closer to the lateral face (25) by 1/10 to ⅓, or altogether, and then
(h) has an S-shape in the area of the shoulder (28), and
(i) toward the end of the higher-placed area of the shoulder (28) has a distance from the lateral face (25) which amounts to ½ to ¾ of the thickness of the knife (20).

6. The knife in accordance with claim 5, characterized in that the thickness of the knife (20) is approximately 3 to 5 mm, preferably approximately 4 mm.

7. The knife in accordance with one of claims 5 or 6, characterized in that in the plane area (23) the cutting edge (24) has a curved shape, viewed from above, which is at an angle β of 60 to 20°, preferably 45°, in respect to the cutting direction (S) approximated to (G).

8. The knife in accordance with one of claims 5 to 8, characterized in that the plane area (23) and the cutting edge (24) have a protrusion (30) ahead of the transition into the shoulder (28), whose width is approximately one-third of the distance (L) between the shoulder (28) and the fastening plate (21), so that an indentation (31) results between the protrusion (30) and the adjoining portion of the cutting edge (24).

9. A device for carving a meat slab (1) out of a portion of a slaughtered animal, which comprises the meat slab (1), the associated rib bones (2) and the associated back bones (3), a first knife (10) for separating the meat slab (1) from the rib bones (2), and a second knife (20) for separating the meat slab (1) from the back bones (3), characterized in that a knife (10) in accordance with one of claims 1 to 4 is used for separation from the rib bones (2), and a knife (20) in accordance with one of claims 5 to 8 is used for separation from the back bones (3).
